(19) United States
(12) Patent Application Publication
(10) Pub. No.: US 2013/0242901 A1
(43) Pub. Date: Sep. 19, 2013

(54) METHOD AND APPARATUS FOR DELIVERING AN OPERATING PARAMETER OF A NEW CARRIER IN A WIRELESS COMMUNICATION NETWORK

(71) Applicant: INNOVATIVE SONIC CORPORATION, Taipei City (TW)

(72) Inventor: Richard Lee-Chee Kuo, Taipei City (TW)

(73) Assignee: INNOVATIVE SONIC CORPORATION, Taipei City (TW)

(21) Appl. No.: 13/795,785

(22) Filed: Mar. 12, 2013

Related U.S. Application Data
(60) Provisional application No. 61/610,193, filed on Mar. 13, 2012.

(51) Int. Cl. H04W 72/04

(52) U.S. Cl. CPC H04W 72/0453
USPC 370/329

(57) ABSTRACT

A method and apparatus are disclosed for delivering an operating parameter of a new carrier associated with a backward compatible carrier. The method includes transmitting, from an eNB (evolved Node B), a frequency spectrum information to indicate whether a frequency spectrum of the new carrier is above or below a frequency spectrum of the backward compatible carrier.

### CROSS-REFERENCE TO RELATED APPLICATIONS

The present application claims the benefit of U.S. Provisional Patent Application Serial No. 61/610,193 filed on Mar. 13, 2012, the entire disclosure of which is incorporated herein by reference.

### FIELD

This disclosure generally relates to wireless communication networks, and more particularly, to a method and apparatus for delivering an operating parameter of a new carrier associated with a backward compatible carrier.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for delivering an operating parameter of a new carrier associated with a backward compatible carrier. The method includes transmitting, from the eNB (evolved Node B), a frequency spectrum information to indicate whether a frequency spectrum of the new carrier is above or below a frequency spectrum of the backward compatible carrier.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flow diagram according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband). WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. 3GPP TS 36.321 V10.4.0, “E-UTRA; MAC protocol specification”; R1-100038. “On definitions of carrier types”; RP-111115, “LTE Carrier Aggregation Enhancements W1D”; R2-115666, “LS on additional carrier types for CA enhancement”; R1-100669, “Benefits of carrier segment”; TS 36.331 V10.4.0, “E-UTRA; RRC protocol specification”. The standards and documents listed above are hereby expressly incorporated herein.

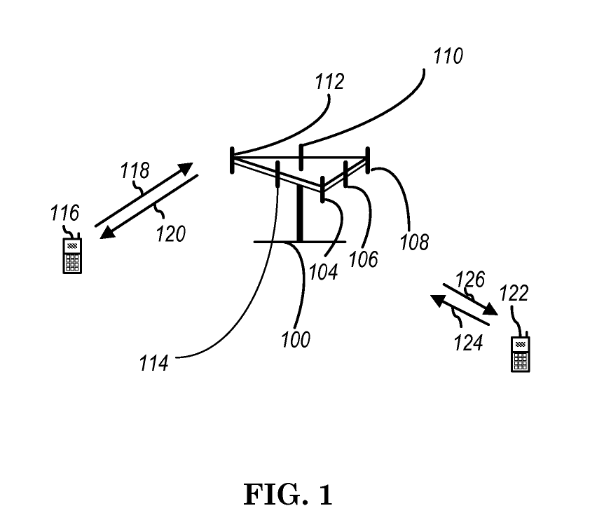

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

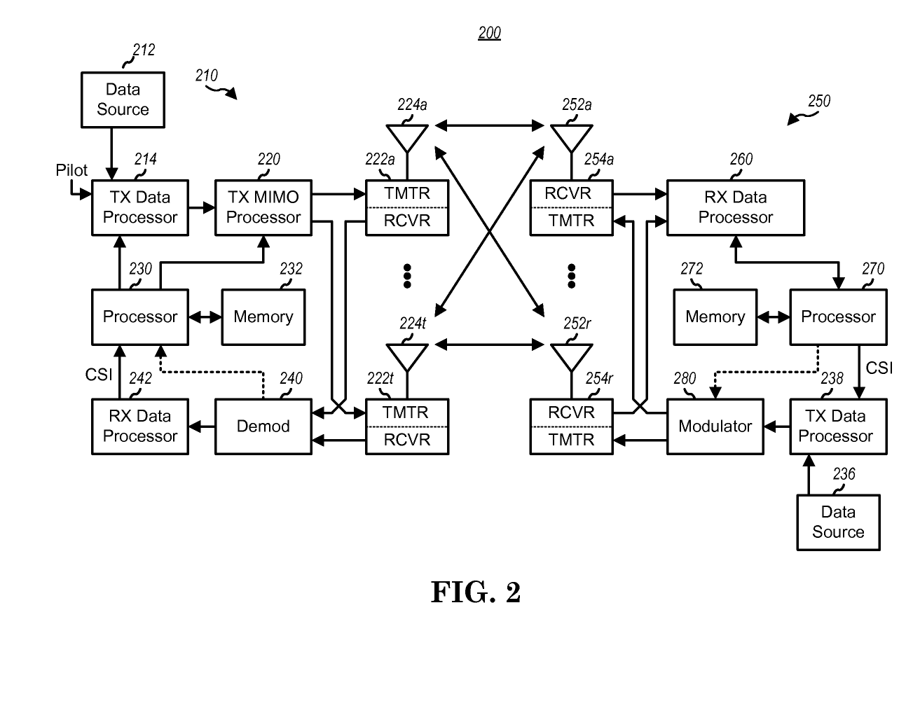

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide, one or more analog signals, and further conditions (e.g., amplifies, filters, and upconverts) the analog signals to provide a modulated signal suitable for transmission over the MIMO channel, N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

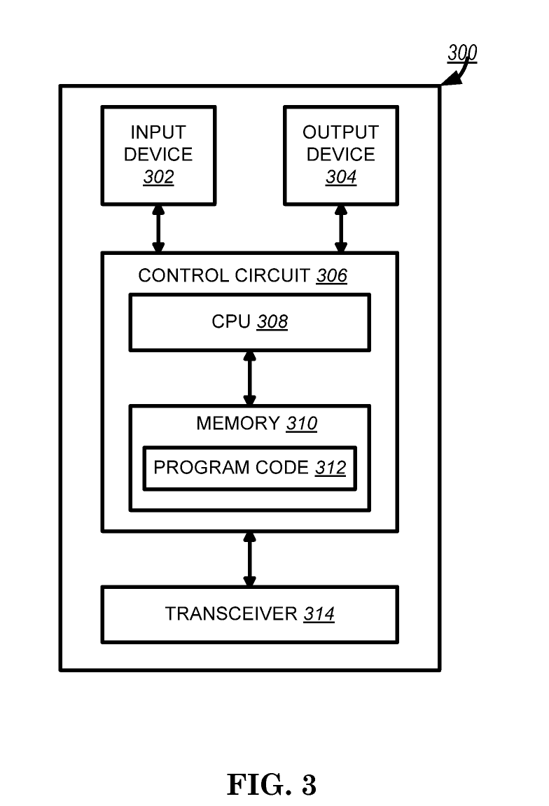

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

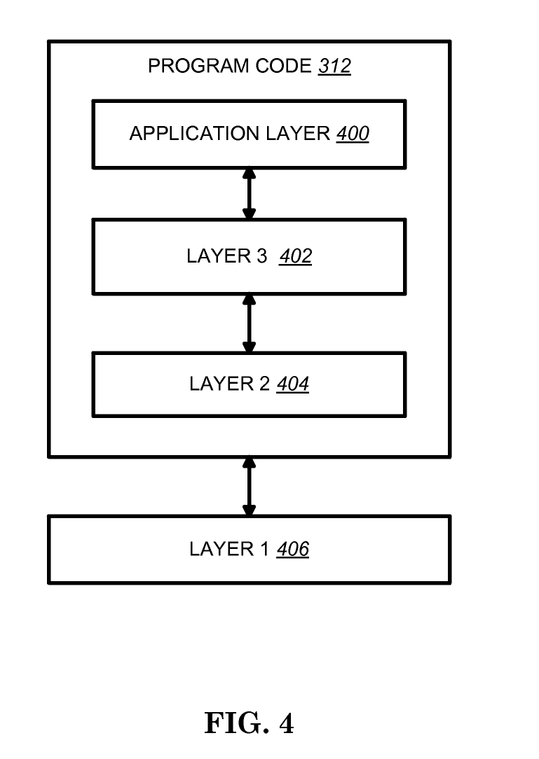

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Carrier aggregation (CA) is generally a feature to support wider bandwidth in LTE-Advanced (LTE-A). A terminal may simultaneously receive or transmit on one or multiple component carriers depending on its capabilities.

In addition to a primary serving cell (Pcell), a UE in RRC_CONNECTED mode may be configured with other secondary serving cells (Scell). Both Pcell and Scell are backward compatible carriers. The Pcell is typically considered as always activated, while an Activation/Deactivation MAC Control Element (CE) could be used to activate or deactivate an Scell according to 3GPP TS 36.321. An sCellDeactivationTimer corresponding to the Scell may also be used for Scell status maintenance i.e. when the sCellDeactivationTimer expires, the corresponding Scell is implicitly considered as deactivated.

Besides backward compatible carriers, 3GPP R1-100038 also defines two following additional carrier types in Rel-10.

Properties of extension carriers:
Supported by carrier aggregation
Non-backwards compatible carrier
Transmission bandwidth is at least from the set of existing values, i.e., {6,
15, 25, 50, 75, 100} RBs. Other transmission bandwidths may be defined
by RAN4.
The sum of backward compatible component carrier and extension carrier
can be more than 110 RBs.
Separate PDCCH indicates the RBs defined within the extension carrier.
It is FFS whether the linkage between backward compatible component
carrier and extension carrier is per UE.
Separate HARQ process running within an extension carrier.
Backward compatible component carrier (to which the extension carrier is
linked to) and the extension carrier can be configured with different
transmission modes.
Extension carriers configuration without CRS is FFS.
Extension carriers can be configured as contiguous or as non-contiguous
to the backwards compatible component carrier they are linked to.
Properties of carrier segments:
Not necessary to have carrier aggregation.
Used to enable additional transmission bandwidths beyond the set of Rel-8
values, i.e., {6, 15, 25, 50, 75, 100} RBs but no more than 110 RBs. What
sets are used is defined by RAN4.
The sum of backward compatible component carrier and segment(s) shall
be no more than 110 RBs. Configurations with sum of backwards
compatible component carrier and segment(s) over 110 RBs are FFS.
One PDCCH indicates the RBs allocated in the sum of backward
compatible carrier and segment(s).
One HARQ process for the sum of backward compatible carrier and
segment(s).
Backward compatible component carrier and segment(s) use the same
transmission mode.
Segments configuration without CRS is FFS.
Segments are contiguous to the component carrier they are associated with.

However, discussion on additional carrier types was postponed to Rel-11 due to time limit for Rel-10. As discussed in 3GPP RP-11115, a new work item of LTE Carrier Aggregation (CA) Enhancements re-opens the discussion on additional carrier types. 3GPP R2-115666 is a liaison (LS) on additional carrier types for CA enhancement that includes the following conclusion and working assumptions:

### Conclusion:

From a RAN1 perspective, the main motivations identified for introducing a new carrier type for carrier aggregation are:
Energy efficiency
   Enhanced spectral efficiency
Improved support for het net

It is for RAN4 to determine whether there is a need for new RF bandwidths to support improved bandwidth scalability.

### Working Assumptions:

introduce at least one new carrier type in Rel-11 (bandwidth agnostic/unknown from a RAN1 point of view), with at least reduced or eliminated legacy control signalling and/or CRS
   at least for the downlink (or for TDD, the downlink subframes on a carrier)
   associated with a backward compatible carrier
   study further:
      issues of synchronisation/tracking (including whether or not PSS/SSS are transmitted) and measurements/mobility
      resource allocation methods
      what RSs are required
For FDD a downlink carrier of the new type may be linked with a legacy uplink carrier, and for TDD a carrier may contain downlink subframes of the new type and legacy uplink subframes.

Note that the current scope of the WI is for CA.

Uplink enhancements are not precluded.

Thus, RAN1 decided to introduce in Rel-11 at least one new carrier type, which would be associated with a backward compatible carrier in a UE. But, it has not been concluded yet which carrier type(s) will be supported. Besides, so far no RRC signaling has been specified for providing operation parameters of a new carrier to a UE.

In Rel-10, operating parameters of an aggregated downlink carrier need to be provided by a serving cell to a UE when an Scell is configured to the UE. For example, information element (IE) dl-Bandwidth indicating the downlink transmission bandwidth and IE dl-CarrierFreq indicating the downlink carrier frequency would be included in a RRCConnectionReconfiguration message transmitted from the serving cell as specified in 3GPP TS36.331. These two parameters or information elements are supposed to be also needed for carrier segment operation in a UE.

According to 3GPP TS 36.331, the IE dl-CarrierFreq would have a value range from 0 to 65535. Thus, it would require sixteen (16) bits in an RRC (Radio Resource Control) signalling to send the IE. However, since a carrier segment is contiguous to its associated legacy carrier, it should be sufficient to indicate to the UE whether the frequency spectrum of the carrier segment is above or below the frequency spectrum of the associated carrier instead of providing IE di-CarrierFreq to the UE. This way only one (1) bit would be needed in the RRC signalling rather than having to use sixteen (16) bits to send the IE dl-CarrierFreq.

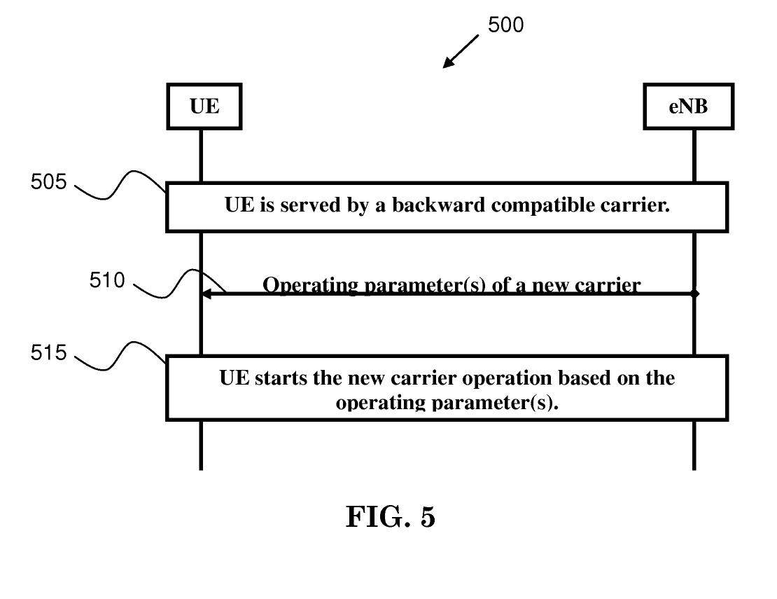

FIG. 5 is a flow diagram according to one exemplary embodiment. In step 505, a UE is served by a backward compatible carrier. In step 510, an eNB transmits at least one operating parameter of the new carrier to the UE. In one embodiment, the at least one operating parameter includes a frequency spectrum information to indicate whether the frequency spectrum of the new carrier is above or below the frequency spectrum of the backward compatible carrier. In step 515, a UE starts the new carrier operation based on the at least one operating parameter.

In another embodiment, the eNB could transmit the at least one operating parameter of the new carrier to the UE via a dedicated RRC (Radio Resource Control) signalling, such as a RRCConnectionReconfiguration message, or via system information broadcasting on the backward compatible carrier. The at least one operating parameter could further include a downlink bandwidth of the new carrier to the UE.

In an alternative embodiment, the new carrier could be a carrier segment, an extension carrier, or a downlink carrier. Furthermore, there would be no system information broadcasting present on the new carrier.

Referring back to FIGS. 3 and 4, the device 300 includes a program code 312 stored in memory 310. In one embodiment, the CPU 308 could execute the program code 312 to transmit, from the eNB (evolved Node B), a frequency spectrum information to indicate whether a frequency spectrum of the new carrier is above or below a frequency spectrum of the backward compatible carrier. In an alternative embodiment, the CPU 308 could execute the program code 312 to receive, at a UE (User Equipment), the frequency spectrum information to indicate whether the frequency spectrum of the new carrier is above or below the frequency spectrum of the backward compatible carrier.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative. the processor may be any conventional processor. controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for delivering an operating parameter of a new carrier associated with a backward compatible carrier, comprising:
transmitting, from an eNB (evolved Node B), a frequency spectrum information to indicate whether a frequency spectrum of the new carrier is above or below a frequency spectrum of the backward compatible carrier.

2. The method of claim 1, wherein the frequency spectrum information is a one-bit value.

3. The method of claim 1, wherein the eNB transmits the frequency spectrum information to a UE (User Equipment) via a dedicated RRC (Radio Resource Control) signalling, such as a RRCConnectionReconfiguration message.

4. The method of claim 1, wherein the eNB transmits the frequency spectrum information to a UE (User Equipment) via system information broadcasting on the backward compatible carrier.

5. The method of claim 1, further comprising the eNB transmitting a downlink bandwidth of the new carrier to a UE (User Equipment).

6. The method of claim 1, wherein the new carrier is a carrier segment, an extension carrier, or a downlink carrier.

7. The method of claim 1, wherein there is no system information broadcasting is present on the new carrier.

8. A communication device for delivering an operating parameter of a new carrier associated with a backward compatible carrier, comprising, the communication device comprising:
a control circuit;
a processor installed in the control circuit;
a memory installed in the control circuit and operatively coupled to the processor;
wherein the processor is configured to execute a program code stored in memory to deliver the operating parameter of the new carrier by:
transmitting, from an eNB (evolved Node B), a frequency spectrum information to indicate whether a frequency spectrum of the new carrier is above or below a frequency spectrum of the backward compatible carrier.

9. The communication device of claim 8, wherein the frequency spectrum information is a one-bit value.

10. The communication device of claim 8, wherein the eNB transmits the frequency spectrum information to a UE (User Equipment) via a dedicated RRC (Radio Resource Control) signalling, such as a RRCConnectionReconfiguration message.

11. The communication device of claim 8, wherein the eNB transmits the frequency spectrum information to a UE (User Equipment) via system information broadcasting on the backward compatible carrier.

12. The communication device of claim 8, further comprising the eNR transmitting a downlink bandwidth of the new carrier to a UE (User Equipment).

13. The communication device of claim 8, wherein the new carrier is a carrier segment, an extension carrier, or a downlink carrier.

14. The communication device of claim 8, wherein there is no system information broadcasting is present on the new carrier.

15. A method for receiving an operating parameter of a new carrier associated with a backward compatible carrier, comprising:
receiving, at a UE (User Equipment), a frequency spectrum information to indicate whether a frequency spectrum of the new carrier is above or below a frequency spectrum of the backward compatible carrier.

16. The method of claim 15, wherein the frequency spectrum information is a one-bit value.

17. The method of claim 15, wherein the UE receives the frequency spectrum information via a dedicated RRC (Radio Resource Control) signalling, such as a RRCConnectionReconfiguration message.

18. The method of claim 15, wherein the UE receives the frequency spectrum information via system information broadcasting on the backward compatible carrier.

19. The method of claim 15, further comprising the UE receiving a downlink bandwidth of the new carrier.

20. The method of claim 15, wherein the new carrier is a carrier segment, an extension carrier, or a downlink carrier.
